(19) United States
(12) Patent Application Publication
(10) Pub. No.: US 2022/0049524 A1
(43) Pub. Date: Feb. 17, 2022

(54) VERTICAL DOOR LATCH ASSEMBLY

(71) Applicant: Carrier Corporation, Palm Beach Gardens, FL (US)

(72) Inventor: Jon Marc Luebeck, Stayton, OR (US)

(21) Appl. No.: 17/254,344

(22) PCT Filed: Jul. 20, 2020
(86) PCT No.: PCT/US2020/042761

§ 371 Date: Dec. 21, 2020

Related U.S. Application Data
(60) Provisional application No. 62/888,651, filed on Aug. 19, 2019.

(51) Int. Cl. E05B 47/00; E05B 47/06; E05B 65/00

(52) U.S. Cl. CPC E05B 47/0012; E05B 47/0603; E05B 2047/0016; E05B 65/0021; E05B 47/0607

(57) ABSTRACT

A vertical door latch assembly includes an electro-mechanical lock assembly and a rotatable engagement feature. A controller is in electrical communication with the electro-mechanical lock assembly. The controller is configured to direct the electro-mechanical lock assembly between a locking position with the electro-mechanical lock assembly in locking engagement with the rotatable engagement feature and a non-locking position with the electro-mechanical lock assembly in non-engagement with the rotatable engagement feature.

### CROSS-REFERENCE TO RELATED APPLICATIONS

This application claims priority to U.S. Provisional Application No. 62/888,651, which was filed on Aug. 19, 2019 and is incorporated herein by reference.

### BACKGROUND

The present disclosure relates to locks for doors that open vertically, such as rollup doors or overhead doors. More specifically, the present disclosure relates to a lock and control system for selectively granting access through rollup or overhead doors.

Self-storage centers typically provide multiple individual storage areas, each of which is accessible through a lockable, vertically opening, rollup door. In existing installations, each customer is provided a traditional keyed lock or provides their own traditional keyed lock to control access to an assigned storage area.

### SUMMARY

In one exemplary embodiment, a vertical door latch assembly includes an electro-mechanical lock assembly and a rotatable engagement feature. A controller is in electrical communication with the electro-mechanical lock assembly. The controller is configured to direct the electro-mechanical lock assembly between a locking position with the electro-mechanical lock assembly in locking engagement with the rotatable engagement feature and a non-locking position with the electro-mechanical lock assembly in non-engagement with the rotatable engagement feature.

In a further embodiment of any of the above, the rotatable engagement feature includes a gear configured to rotate with an axle.

In a further embodiment of any of the above, the electro-mechanical lock assembly includes a pawl that is configured to move between a first position in locking engagement with the gear and a second position spaced from the gear.

In a further embodiment of any of the above, the electro-mechanical lock assembly includes a motor attached to the pawl to move the pawl between the first position and the second position.

In a further embodiment of any of the above, the electro-mechanical lock assembly includes a retractable latch.

In a further embodiment of any of the above, the retractable latch is configured to extend into the locking position in engagement with the rotatable engagement feature and retract into the non-locking position spaced from the rotatable engagement features.

In another exemplary embodiment, a vertical door assembly includes a plurality of slats supported by a support structure. An electro-mechanical lock assembly is fixed relative to the support structure. A rotatable engagement feature is attached to one of the support structure or the plurality of slats. A controller is in electrical communication with the electro-mechanical lock assembly and is configured to direct the electro-mechanical lock assembly between the locked position and the unlocked position.

In a further embodiment of any of the above, the support structure includes an axle supported by at least one bracket.

In a further embodiment of any of the above, the rotatable engagement feature includes a gear that is configured to rotate with the axle.

In a further embodiment of any of the above, the electro-mechanical lock assembly includes a pawl that is configured to move between a first position in locking engagement with the gear and a second position spaced from the gear.

In a further embodiment of any of the above, the electro-mechanical lock assembly includes a motor attached to the pawl to move the pawl between the first position and the second position.

In a further embodiment of any of the above, the electro-mechanical lock assembly includes a retractable latch configured to move between an extended position in engagement with the rotatable engagement feature and a retracted position spaced from the rotatable engagement features.

In a further embodiment of any of the above, the rotatable engagement feature is rigidly attached the vertical door assembly and the vertical door assembly includes a plurality of slats and a drum at least partially supported by an axle.

In another exemplary embodiment, a method of operating a vertical door latch assembly includes the step of sending a signal from a controller to an electro-mechanical lock assembly to move the electro-mechanical lock assembly to one of a locking position in locking engagement with a rotatable engagement feature on a vertical door assembly and a non-locking position in non-engagement with the rotatable engagement feature on the vertical door assembly. A retention feature on the electro-mechanical lock assembly is moved into engagement with a rotatable engagement feature if the signal indicated the locking position. The retention feature on the electro-mechanical lock assembly is moved out of engagement with the rotatable engagement feature if the signal indicated the non-locking position.

In a further embodiment of any of the above, the rotatable engagement feature includes a gear attached to an axle at least partially supporting a plurality of slats of the vertical door assembly.

In a further embodiment of any of the above, the electro-mechanical lock assembly includes a motor configured to move a pawl between the locking position in locking engagement with the gear and the non-locking position in non-engagement with the gear.

In a further embodiment of any of the above, the gear is located on an axle at least partially supporting a plurality of slats in the vertical door assembly.

In a further embodiment of any of the above, the rotatable engagement feature includes a stop attached to the vertical door assembly.

In a further embodiment of any of the above, the electro-mechanical lock assembly includes a retractable latch configured to extend into the locking position in engagement with the rotatable engagement feature and retract into the non-locking position spaced from the rotatable engagement features.

In a further embodiment of any of the above, the vertical door assembly includes a plurality of slats and a drum at least partially supported by an axle.

### BRIEF DESCRIPTION OF THE DRAWINGS

FIG. 1 illustrates an interior view of an example vertical door.

FIG. 2 illustrates an exterior view of the example vertical door of FIG. 1.

FIG. 3 illustrates an enlarged view of an example electro-mechanical lock assembly adjacent the vertical door.

FIG. 4 illustrates an enlarged view of another example electro-mechanical lock assembly adjacent the vertical door.

### DETAILED DESCRIPTION

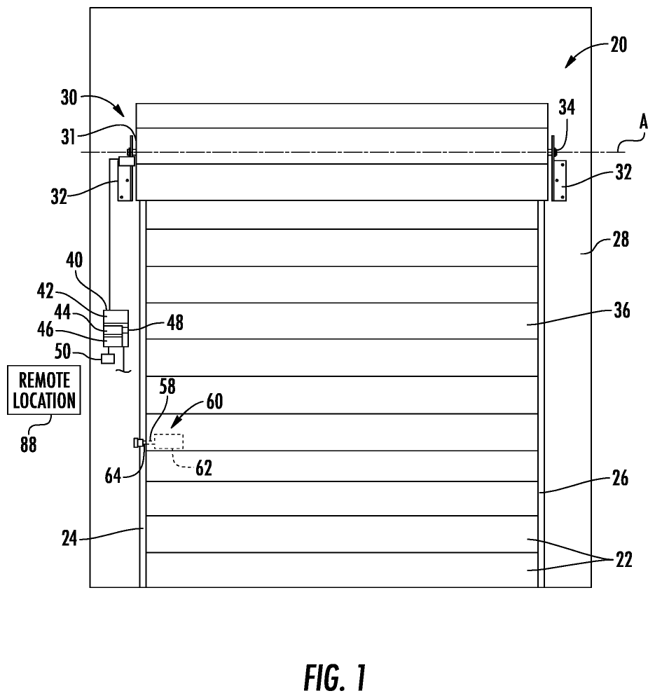

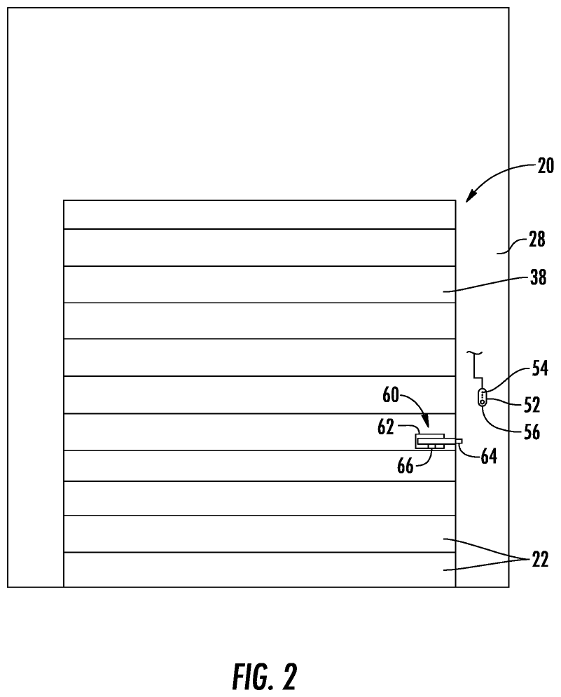

FIGS. 1 and 2 illustrate an example vertical door assembly 20, such as a rollup or overhead style door. The vertical door assembly 20 includes a plurality of slats 22 that are rotatably connected to each other along their length and slideably connected to a first vertical guide rail 24 and a second vertical guide rail 26 along respective opposite ends of the slats 22. In the illustrated example, the vertical door assembly 20 is used to selectively enclose an opening in a wall 28. The plurality of slats 22 include an interior surface 36 (FIG. 1) that faces towards an enclosed space and an exterior surface 38 (FIG. 2) that faces away from the enclosed space. The wall 28 could be a wall locating a building, a shipping container, a trailer, or any other type of arrangement where it is desirable to selectively enclose an opening in a structure.

The vertical door assembly 20 includes a tension wheel assembly 30 having a drum 31 supported by an axle 34 to allow the plurality of slats 22 to move through the first and second vertical guide rails 24, 26 and collapse into a closed position. The tension wheel assembly 30 allows the plurality of slats 22 to roll around the axle 34 about an axis of rotation A to store the plurality of slats 22 above the opening in the wall 28. Additionally, the tension wheel assembly 30 could be spring loaded to reduce the force needed to raise the plurality of slats 22. In the illustrated example, the axle 34 is supported relative to the wall 28 through a bracket 32 located adjacent opposite ends of the axle 34 and fixed relative to the wall 28. A bolt assembly 60 having a bolt 64 located in a bolt housing 62 attached to the exterior surface 38 may be used to further lock the plurality of slats 22 from moving by engagement an aperture 58 in the first vertical guide rail 24 (FIGS. 1 and 2).

The vertical door assembly 20 utilizes an electronic control module 40 in electrical communication with an electro-mechanical lock assembly 70 that selectively fixes the axle 34 from rotating to secure the plurality of slats 22 remain in a closed position. In the illustrated example, the electronic control module 40 includes a printed circuit board in communication with memory 42, a processor 44, a wireless communications device 46, and at least one indicator light 48. The memory 42 is preprogrammed and in communication with the processor 44, such as a controller, to perform the operations described below.

In one example, the wireless communications device 46 is capable of forming a Wi-Fi or Bluetooth connection to transfer a desired locked or unlocked request from a user wirelessly to the wireless communications device 46 to change an operating state of the electro-mechanical lock assembly 70. The electronic control module 40 may also utilize the at least one indicator light 48 to display a connection status with the user formed with the wireless communications device 46 and/or a locked status of the electro-mechanical lock assembly 70. The electronic control module 40 may also be in electrical communication with a battery backup 50 to provide power to the electronic control module 40 during power outages to ensure that a sure is able to maintain access to the enclosed space through the vertical door assembly 20.

An interface 52 may also be in electrical communication with the electronic control module 40 and located adjacent the exterior surface 38 of the vertical door assembly 20 to allow a user adjacent to the exterior surface 38 of the vertical door assembly 20 to be able to communicate with the electronic control module 40. The interface 52 may include at least one light 54 that indicates a locked status of electro-mechanical lock assembly 70 and/or a connection status with the user formed with the wireless communications device 46.

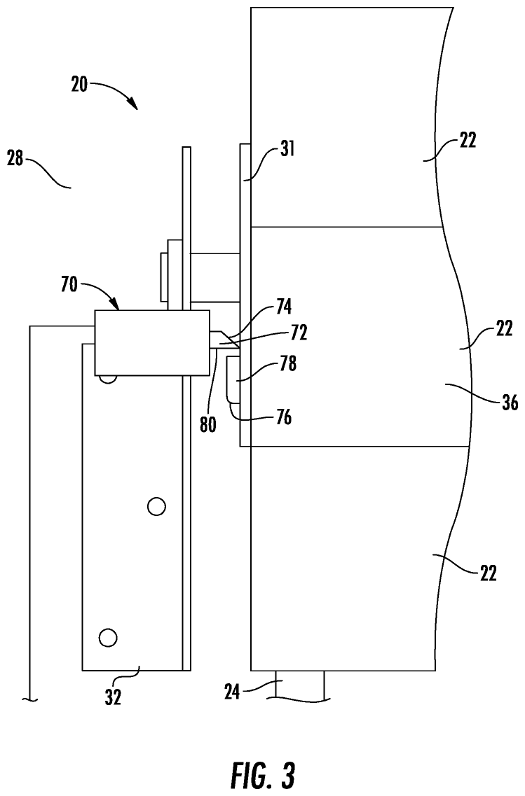

FIG. 3 illustrates an enlarged view of the electro-mechanical lock assembly 70. The electro-mechanical lock assembly 70 is in electrical communication with the electronic control module 40 to receive signals to move between a locked and an unlocked position. In order to lock the slats 22 from moving vertically, the electro-mechanical lock assembly 70 is fixed relative to one of the brackets 32 or another static structure, such as the wall 28.

The electro-mechanical lock assembly 70 includes a latch 72 that is selectively retracted to a non-locking position spaced from a rotatable engagement feature, such as a door stop 78, and selectively extended to a locking position in engagement with the door stop 78. When the latch 72 is in the extended position, the plurality of slats 22 are able to be rolled down from the tension wheel assembly 30 because the latch 72 includes a slanted surface 74 that engages a slanted surface 76 on the door stop 78 to move the latch 72 into a retracted position as is passes the latch 72.

In the illustrated example, the door stop 78 is located on the drum 31 between the axle 34 and the wall 28. Alternatively, the door stop 78 could be located on the interior surface 36 of at least one of the plurality of slats 22 During operation when the latch 72 is in the extended position, a stop contact surface 80 on the latch 72 engages a latch contact surface 82 on the door stop 78 to prevent the drum 31 and/or the plurality of slats 22 from allowing the vertical door assembly to move vertically to an open position and allow access into the opening through the wall 28.

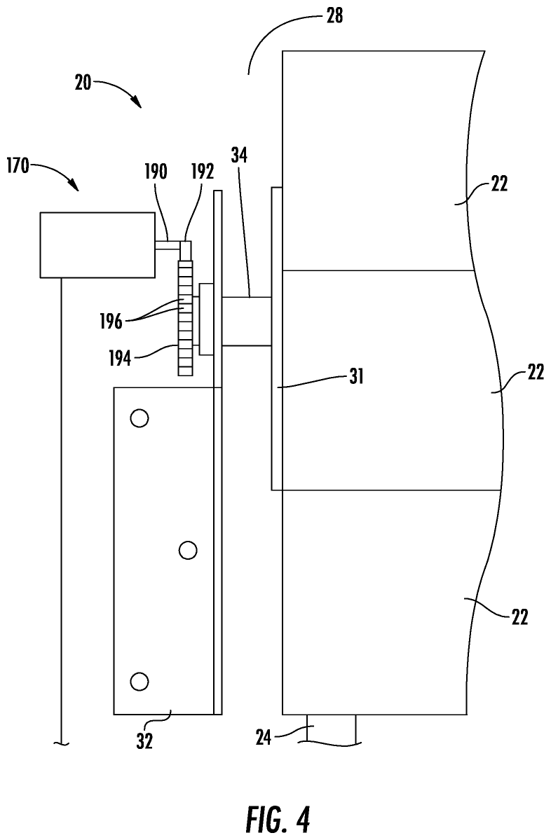

FIG. 4 illustrates another example electro-mechanical lock assembly 170 that also prevents the axle 34 from rotating to secure the plurality of slats 22 in the locked position. The electro-mechanical lock assembly 170 is in electrical communication with the electronic control module 40 to receive signals to move between a locked and an unlocked position. In order to lock the slats 22, the electro-mechanical lock assembly 170 is fixed relative to one of the brackets 32 or another static structure such as the wall 28.

The electro-mechanical lock assembly 170 includes a motor that drives a shaft 190 to move a pawl 192 into and out of engagement with a gear 194 fixed relative to the axle 34. The gear 194 includes a plurality of teeth 196 that allow the pawl 192 multiple locations to engage the gear 194 and fix the pawl 192 into the teeth 196 to prevent the axle 34 from rotating.

During operation of the electro-mechanical lock assembly 70, 170, a user communicates with the electronic control module 40 through at least one of the wireless communications device 46 or the interface 52. The communication between the user and the wireless communications device 46 may occur through an application or web interface on a user's mobile device through a Bluetooth or other type of wireless connection. The electronic control module 40 can then send an electrical signal to the electro-mechanical lock assembly 70, 170 to selectively lock the slats 22 from opening by moving between a locking position and a non-locking position as described above.

Additionally, the electronic control module 40 can store a record of the user that accessed the wireless communications device 46 on the memory 42 on the electronic control module 40. The record can include the identity of the user based on the device used to access the wireless communications device 46 and the time of the request. Alternatively, the electronic control module 40 can send the record to a remote location 88 (FIG. 1) through use of the wireless communications device 46 to monitor access through the vertical door assembly 20. Additionally, the remote location 88 can send a signal to the electronic control module 40 through the wireless communications device 46 to direct the electro-mechanical lock assembly 70, 170 to move between one of the locking position and non-locking position.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A vertical door latch assembly comprising:
an electro-mechanical lock assembly;
a rotatable engagement feature; and
a controller in electrical communication with the electro-mechanical lock assembly and configured to direct the electro-mechanical lock assembly between a locking position with the electro-mechanical lock assembly in locking engagement with the rotatable engagement feature and a non-locking position with the electro-mechanical lock assembly in non-engagement with the rotatable engagement feature.

2. The assembly of claim 1, wherein the rotatable engagement feature includes a gear configured to rotate with an axle.

3. The assembly of claim 2, wherein the electro-mechanical lock assembly includes a pawl configured to move between a first position in locking engagement with the gear and a second position spaced from the gear.

4. The assembly of claim 3, wherein the electro-mechanical lock assembly includes a motor attached to the pawl to move the pawl between the first position and the second position.

5. The assembly of claim 1, wherein the electro-mechanical lock assembly includes a retractable latch.

6. The assembly of claim 5, wherein the retractable latch is configured to extend into the locking position in engagement with the rotatable engagement feature and retract into the non-locking position spaced from the rotatable engagement features.

7. A vertical door assembly comprising:
a plurality of slats supported by a support structure;
an electro-mechanical lock assembly fixed relative to the support structure;
a rotatable engagement feature attached to one of the support structure or the plurality of slats; and
a controller in electrical communication with the electro-mechanical lock assembly and configured to direct the electro-mechanical lock assembly between the locked position and the unlocked position.

8. The assembly of claim 7, wherein the support structure includes an axle supported by at least one bracket.

9. The assembly of claim 8, wherein the rotatable engagement feature includes a gear configured to rotate with the axle.

10. The assembly of claim 9, wherein the electro-mechanical lock assembly includes a pawl configured to move between a first position in locking engagement with the gear and a second position spaced from the gear.

11. The assembly of claim 10, wherein the electro-mechanical lock assembly includes a motor attached to the pawl to move the pawl between the first position and the second position.

12. The assembly of claim 7, wherein the electro-mechanical lock assembly includes a retractable latch configured to move between an extended position in engagement with the rotatable engagement feature and a retracted position spaced from the rotatable engagement features.

13. The assembly of claim 7, wherein the rotatable engagement feature is rigidly attached the vertical door assembly and the vertical door assembly includes a plurality of slats and a drum at least partially supported by an axle.

14. A method of operating a vertical door latch assembly comprising the steps of:
sending a signal from a controller to an electro-mechanical lock assembly to move the electro-mechanical lock assembly to one of a locking position in locking engagement with a rotatable engagement feature on a vertical door assembly and a non-locking position in non-engagement with the rotatable engagement feature on the vertical door assembly; and
moving a retention feature on the electro-mechanical lock assembly into engagement with a rotatable engagement feature if the signal indicated the locking position and moving the retention feature on the electro-mechanical lock assembly out of engagement with the rotatable engagement feature if the signal indicated the non-locking position.

15. The method of claim 14, wherein the rotatable engagement feature includes a gear attached to an axle at least partially supporting a plurality of slats of the vertical door assembly.

16. The method of claim 15, wherein the electro-mechanical lock assembly includes a motor configured to move a pawl between the locking position in locking engagement with the gear and the non-locking position in non-engagement with the gear.

17. The method of claim 16, wherein the gear is located on an axle at least partially supporting a plurality of slats in the vertical door assembly.

18. The method of claim 14, wherein the rotatable engagement feature includes a stop attached to the vertical door assembly.

19. The method of claim 18, wherein the electro-mechanical lock assembly includes a retractable latch configured to extend into the locking position in engagement with the rotatable engagement feature and retract into the non-locking position spaced from the rotatable engagement features.

20. The method of claim 19, wherein the vertical door assembly includes a plurality of slats and a drum at least partially supported by an axle.
